(19) United States
(12) Patent Application Publication
(10) Pub. No.: US 2015/0273363 A1
(43) Pub. Date: Oct. 1, 2015

(54) SHAKER PIT HAVING REDUCED SIZE AND/OR WEIGHT

(71) Applicant: M-I LLC, Houston, TX (US)

(72) Inventor: Joe M. Sherwood, Columbus, TX (US)

(21) Appl. No.: 14/433,503

(22) PCT Filed: Oct. 4, 2013
(86) PCT No.: PCT/US2013/063517

§ 371 Date: Apr. 3, 2015

Related U.S. Application Data
(60) Provisional application No. 61/709,852, filed on Oct. 4, 2012.

(51) Int. Cl. B01D 21/28

(52) U.S. Cl. CPC B01D 21/28

(57) ABSTRACT

This disclosure is generally drawn to systems, devices, apparatus, and/or methods related to reduced size and/or weight shaker pit systems that separate solids, contaminants, and/or undesirable objects from drilling fluid, in some examples, a first pit of a shaker pit may receive drilling fluid for filtering solids. The first pit may include retention wall(s) to decrease the flow speed of the drilling fluid, thus enhancing settling capacity. The drilling fluid may flow from the first pit to a second pit via valve(s). The drilling fluid may also flow from the second pit to a third pit via valve(s). Pipe(s) may be positioned adjacent to the pits and may be configured to channel at least some of the drilling fluid out of the shaker pit.

### BACKGROUND

The present disclosure contemplates that oil drilling operations typically include shaker pits (or shaker tanks) to separate contaminants and/or undesirable objects from drilling fluid (or mud).

The present disclosure further contemplates that size and weight restrictions are present in certain oil drilling environments. For example, offshore cantilevered drilling rigs may benefit from more compact and/or lighter drilling equipment. In certain types of cantilevered jack up drilling rigs, the need for saving weight and/or space is desirable because the shaker house is typically mounted within the cantilevered arm, which moves out away from the center of gravity of the rig, when in drilling mode. In some cantilevered rigs, a weight reduction in the cantilevered arm translates to almost triple the reduction of required weight on the main deck due to known physics principles.

Therefore, size and/or weight reduction of shaker pits in certain oil drilling environments may be desirable.

### BRIEF DESCRIPTION OF THE DRAWINGS

The foregoing and other features of the present disclosure will become more fully apparent from the following description, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 depicts a top perspective view of an example shaker pit;

FIG. 2 depicts a bottom perspective view of the example shaker pit of FIG. 1;

FIG. 3 depicts a detailed view of the underside of another example shaker pit;

FIG. 4 depicts a detailed view of the topside of another example shaker pit; and

FIGS. 5-15 depict various views of the example shaker pit of FIG. 1; all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described herein are not meant to be limiting. Other embodiments may be utilized, and other changes may be made, without departing from the spirit or scope of the subject matter presented here, It will be readily understood that the aspects of the present disclosure, as generally described herein, and illustrated in the Figures, may be arranged, substituted, combined, and designed in a wide variety of different configurations, all of which are explicitly contemplated and make part of this disclosure.

This disclosure is drawn to systems, devices, apparatus, and/or methods related to shaker pit systems for drilling environments. Specifically, the disclosed systems, devices, apparatus, and/or methods relate to reduced size and/or weight shaker pit systems that separate solids, contaminants, and/or undesirable objects from drilling fluid.

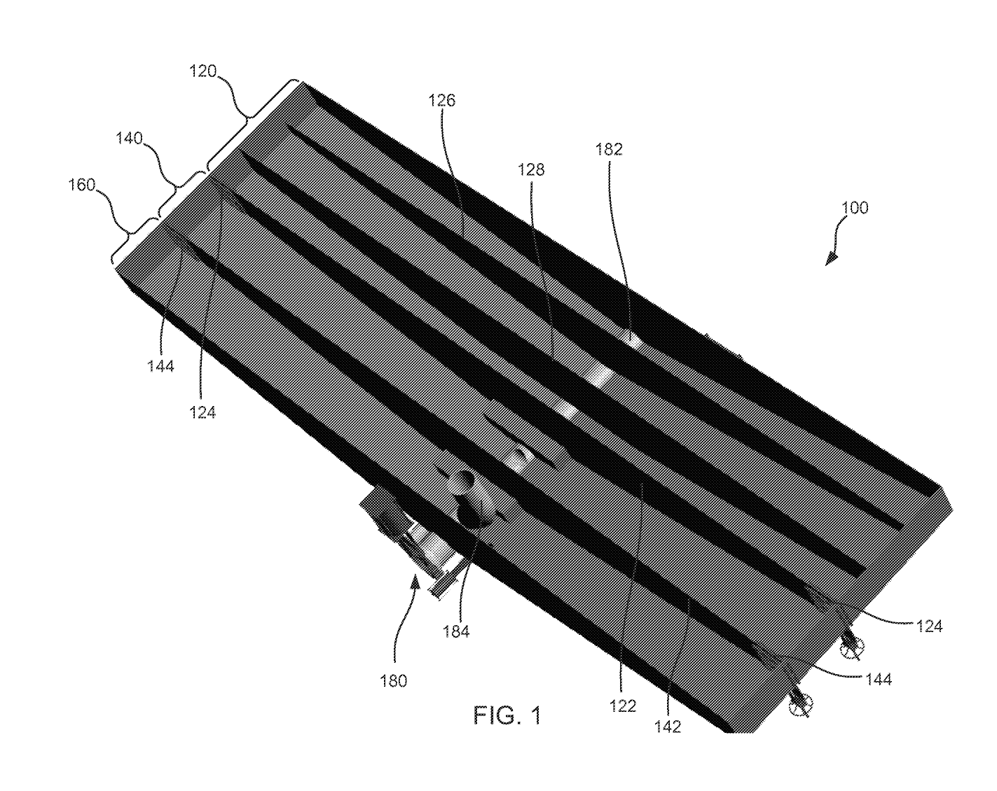

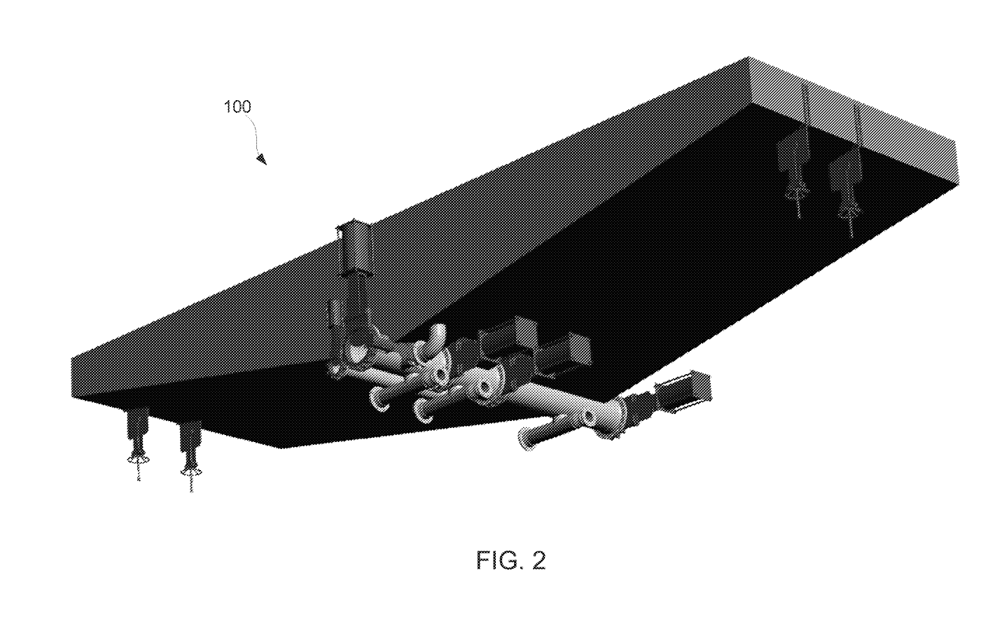

FIG. 1 depicts a top perspective view of an example shaker pit 100. FIG. 2 depicts a bottom perspective view of example shaker pit 100. Shaker pit 100 may include three pits 120, 140, 160. The first pit 120 may be separated from the second pit 140 via divider wall 122. Similarly, the second pit 140 may be separated from the third pit 160 via divider wall 142.

The first pit 120 may receive drilling fluid for filtering. Drilling fluid may be transferred to the first pit 120 in any manner. The first pit 120 may be configured to separate solids (e.g., sand) and/or similar objects from the drilling fluid. The first pit 120 may include retention wall(s) 126, 128 to decrease the flow speed of the drilling fluid (e.g., reduce the speed in which the fluid exits the first pit 120), thus enhancing settling capacity. In some examples, the longer the drilling fluid spends in the first pit 120, the higher the probability that solids settle at the bottom of the first pit 120 (and thus separates from the drilling fluid).

In the example of FIG. 1, the first pit 120 includes two retention walls 126, 128. The retention walls 126, 128 may be the same height or have different heights. The example in FIG. 1 depicts retention wall 128 having a greater height than retention wall 126. The retention walls 126, 128 may be situated within the first pit 120 such that drilling fluid may flow over the retention wall (as depicted by retention wall 126 in FIG. 1) and/or under the retention wall (as depicted by retention wall 128 in FIG. 1). In this manner, the flow of the drilling fluid may be slowed, thus enhancing settling capacity.

Drilling fluid may flow from the first pit 120 to the second pit 140 via valve(s) 124 (e.g., knife gate valves andor other similar valves). In FIG. 1, the valve(s) 124 are inverted, but, in some examples, the valve(s) 124 may not be inverted. The valve(s) 124 may allow, restrict (partially or completely) the drilling fluid to enter the second pit 140. Valve(s) 124 may be operated manually andor automatically via a controlling device. In some examples, the valve(s) 124 may allow only a portion of the drilling fluid to enter the second pit 140. In this manner, the direction, rate, and/or speed of the flow may be controlled. For example, restricting flow from the first pit 120 to the second pit 140 may create a greater retention time in the first pit 120, thus potentially enhancing settling capacity in the first pit 120.

Similarly, the drilling fluid may flow from the second pit 140 to the third pit 160 via valve(s) 144 (e.g., knife gate valves andor other similar valves). In FIG. 1, the valve(s) 144 are inverted, but, in some examples, the valve(s) 144 may not be inverted. The valve(s) 144 may allow, restrict (partially or completely) the drilling fluid to enter the third pit 160. Valve(s) 144 may be operated manually and/or automatically via a controlling device. In some examples, the valve(s) 144 may allow only a portion of the drilling fluid to enter the third pit 160. In this manner, the direction, rate, andor speed of the flow may be controlled. For example, restricting flow from the second pit 140 to the third pit 160 may create a greater retention time in the second pit 140, thus potentially enhancing settling capacity in the second pit 140.

A pipe system 180 may be positioned adjacent to the pits 120, 140, 160 and may be configured to channel at least some of the drilling fluid out of the shaker pit 100. In some examples, the pipe system 180 may be underneath or below the pits 120, 140, 160 such that gravity assists the drilling fluid into the pipe system 180. The pipe system may include a pipe 182 that runs along the entirety (or substantially the entirety) of the pits 120, 140, 160.

The pipe system 180 may include an overflow pipe 184 (which may be in fluid communication with the pipe 182). The overflow pipe 184 may allow the drilling fluid to exit the third pit 460. In some examples, the overflow pipe 184 may be substantially vertical (as opposed to the horizontal configuration of the pipe 182). When the drilling fluid level in the third pit 160 exceeds the height of the inlet or mouth of the overflow pipe 184, the drilling fluid may enter the overflow pipe 184. With the assistance of gravity, the drilling fluid flows down the overflow pipe 184 and into the pipe 182. The pipe 182 then channels the drilling fluid out of and away from the shaker pit 100. In some examples, the overflow pipe 184 may be in fluid communication with andor coupled to the pipe 182.

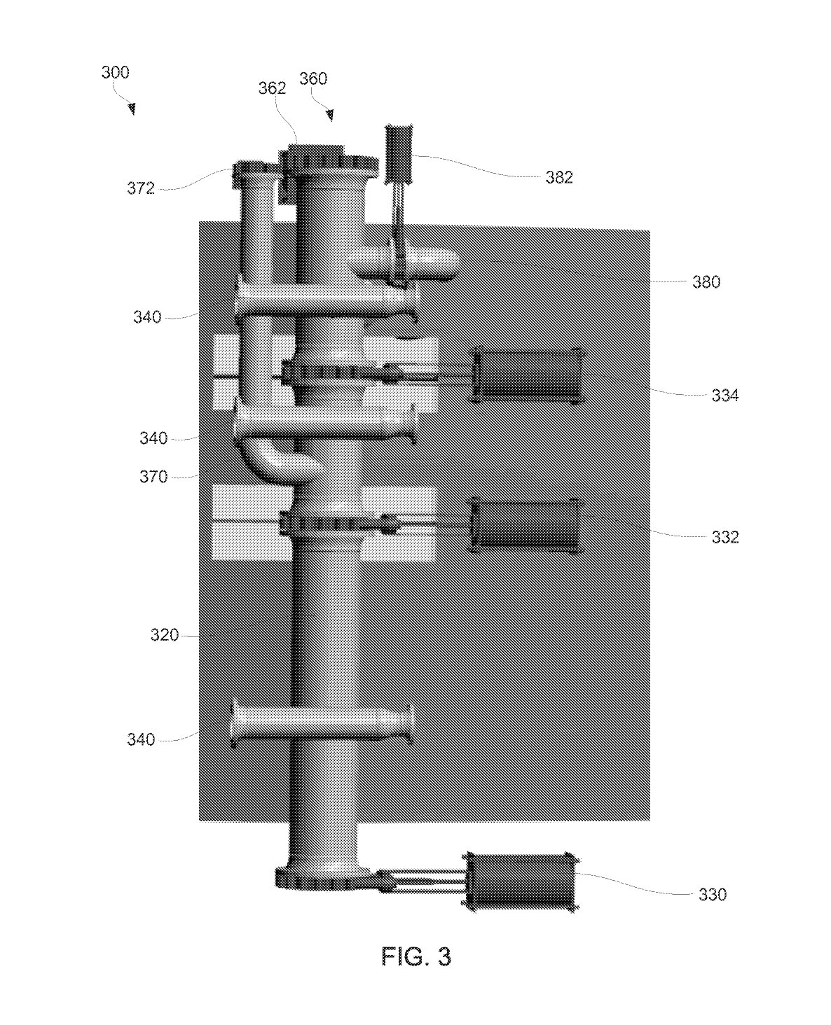

FIG. 3 depicts a detailed view of the underside of an example shaker pit 300. The shaker pit 300 may include a pipe 320 in fluid communication with first, second, and/or third pits of shaker pit 300. The pipe 320 may temporarily be effectively separated into multiple sections via operation of valve(s) 330, 332, 334 (e.g., knife gate valves andor similar valve(s)). In some examples, the shaker pit 300 may include suction point(s) 340 for centrifugals, and PDPs may be present for secondary cleaning equipment andor transfer. The pipe 320 may allow drilling fluid to exit at outlet 360. The outlet 360 may be controlled via valve(s) 362 (e.g., knife gate valves andor similar valves).

In some examples, the pipe 320 may include a bypass pipe 370 to allow the drilling fluid to bypass the third pit (if desired). Valve(s) 372 (e.g., knife gate valves andor similar valves) may open or close to allow drilling fluid to bypass the second pit. Similarly, the pipe 320 may include a cleaning pipe 380, which may be useful in the cleaning andor washing the third pit. Valve(s) 382 (e.g., knife gate valves andor similar valves) may open or close to use the cleaning pipe 380. Cleaning fluid (e.g., water, chemicals) may be injected to andor transferred to the shaker pit 300 via the cleaning pipe 380.

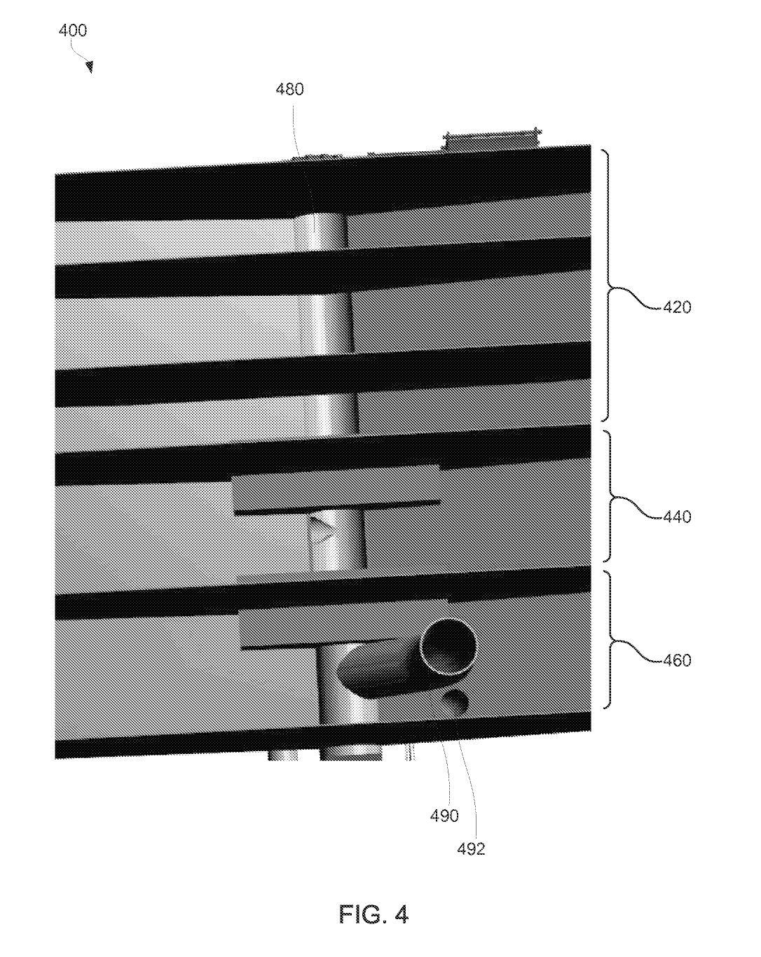

FIG. 4 depicts a detailed view of the topside of an example shaker pit 400. The shaker pit 400 may include a pipe 480 that extends at least a portion of the length of and at least partially through the first pit 420, the second pit 440, and the third pit 460, The third pit 460 may include an overflow pipe 490 that allows drilling fluid to exit the third pit 460 when the drilling fluid level exceeds the height of the inlet or mouth of the overflow pipe 490. The overflow pipe 490 may be in fluid communication with andor coupled to the pipe 480. Cleaning pipe 492 may be useful in the cleaning andor washing of third pit 460.

In some examples, the pipe 480 may be open topped in the first pit 420 and the second pit 440. In some examples, the pipe 480 may be closed topped in the third pit 460 such that the only fluid exit is via the overflow pipe 490.

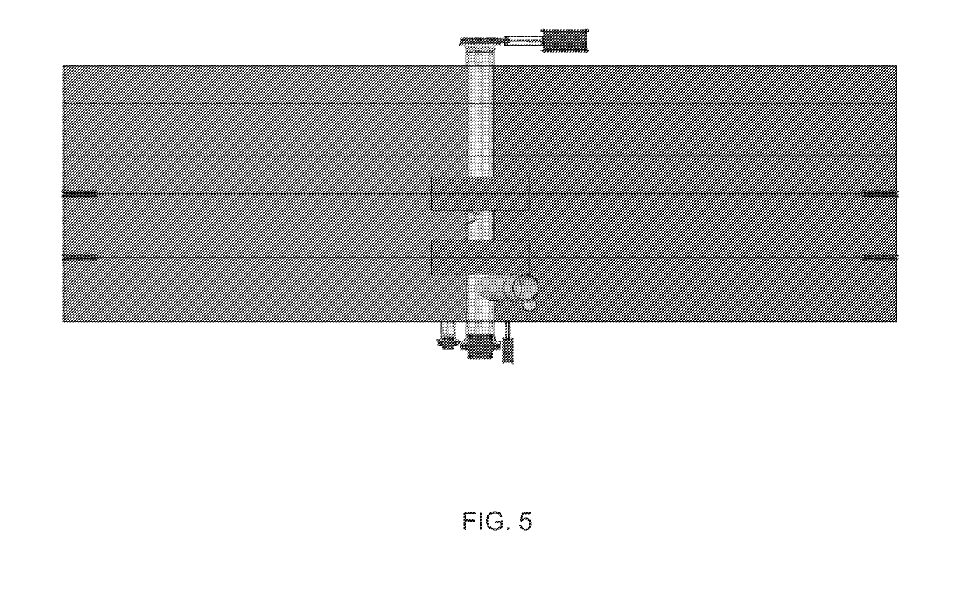

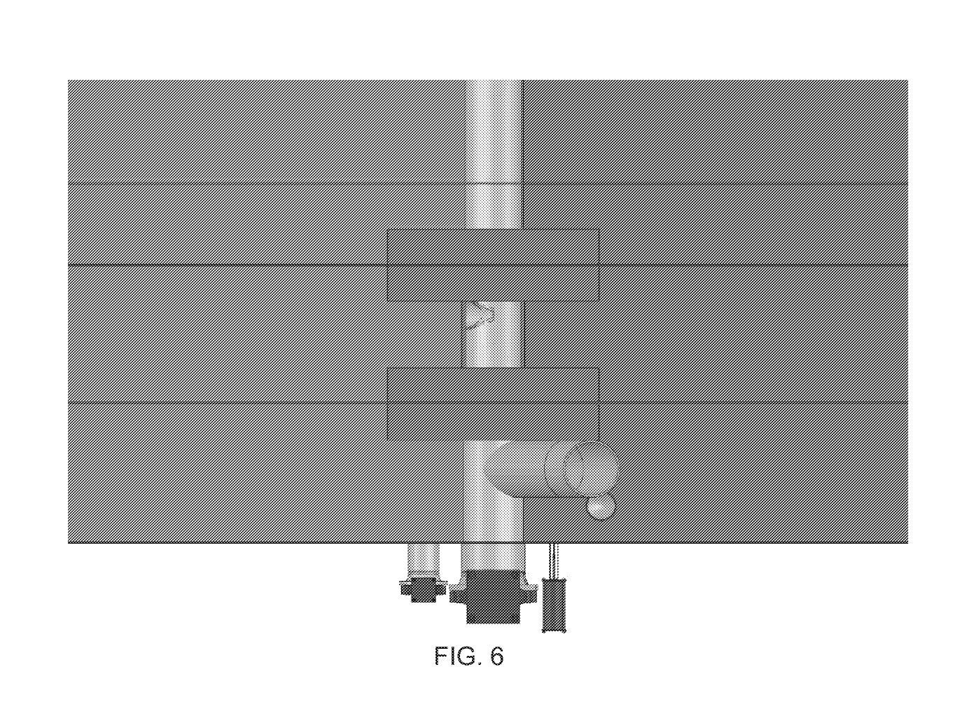

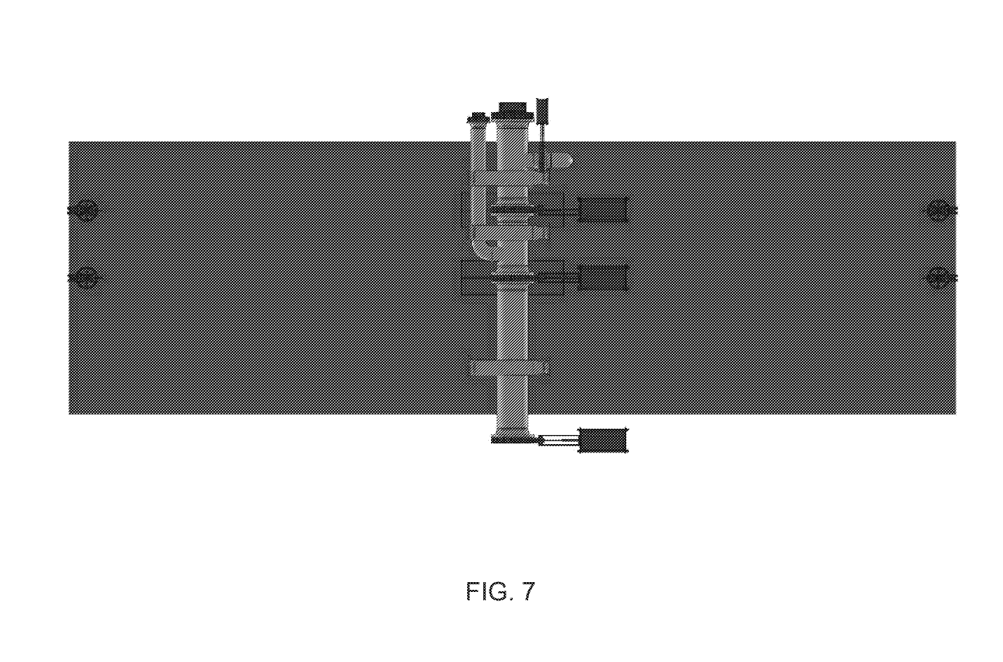

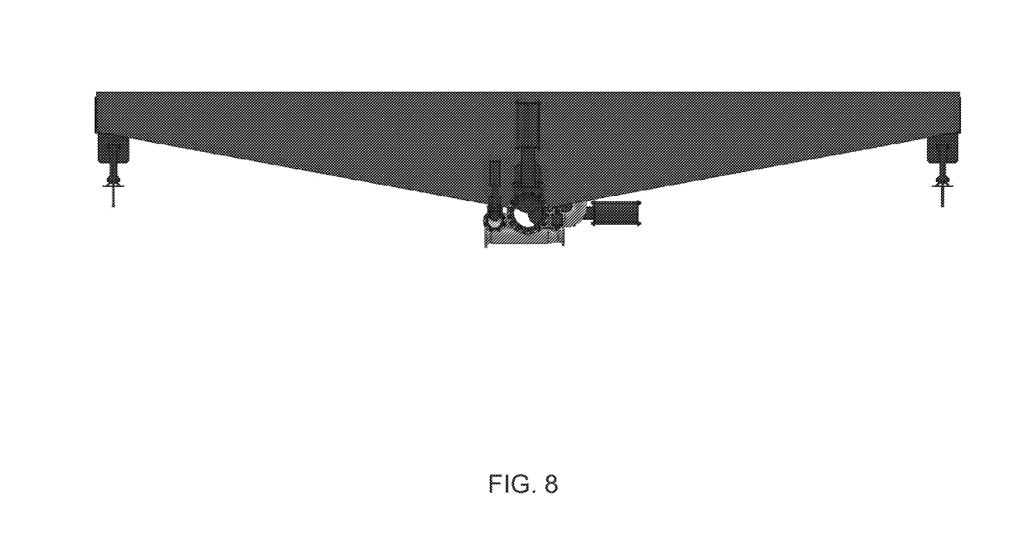

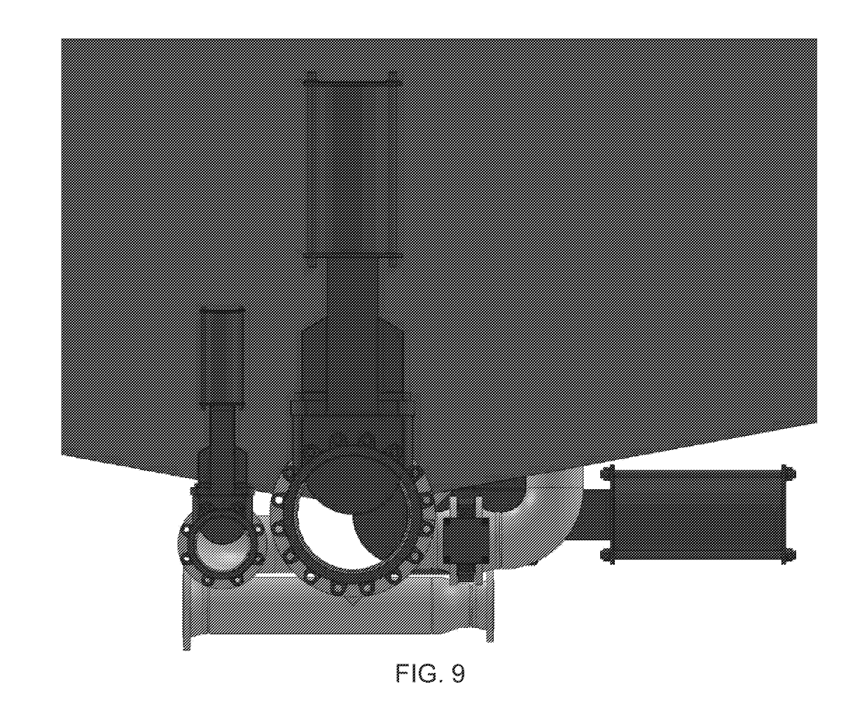

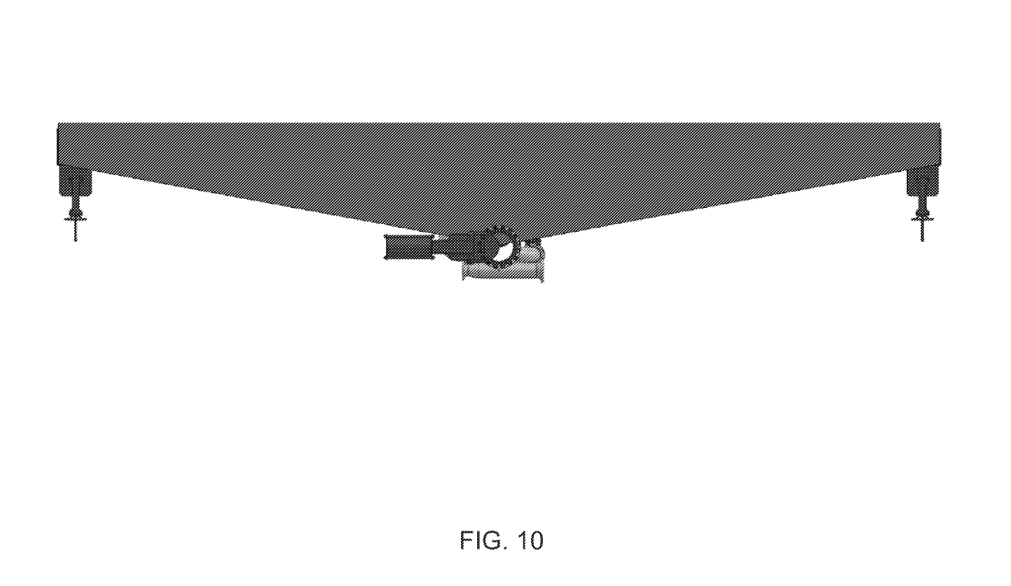

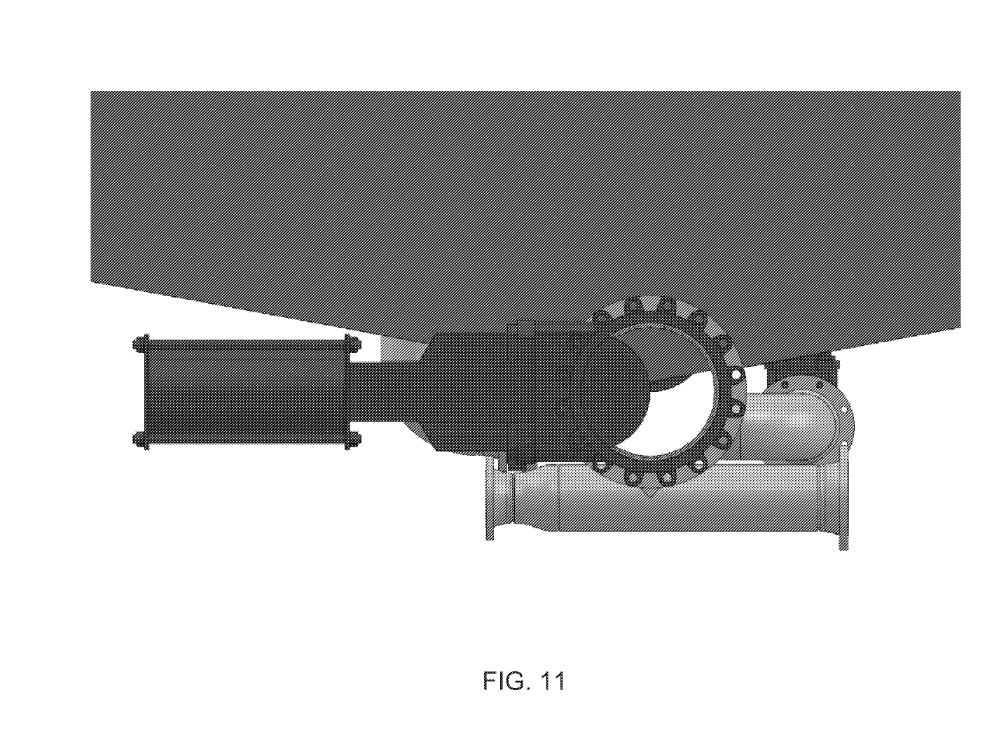

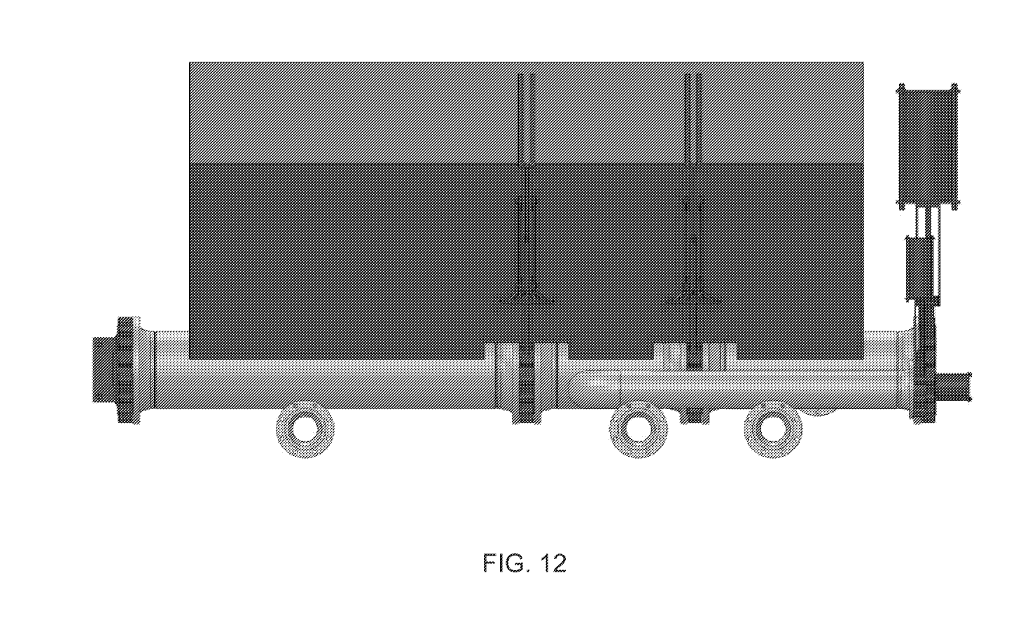

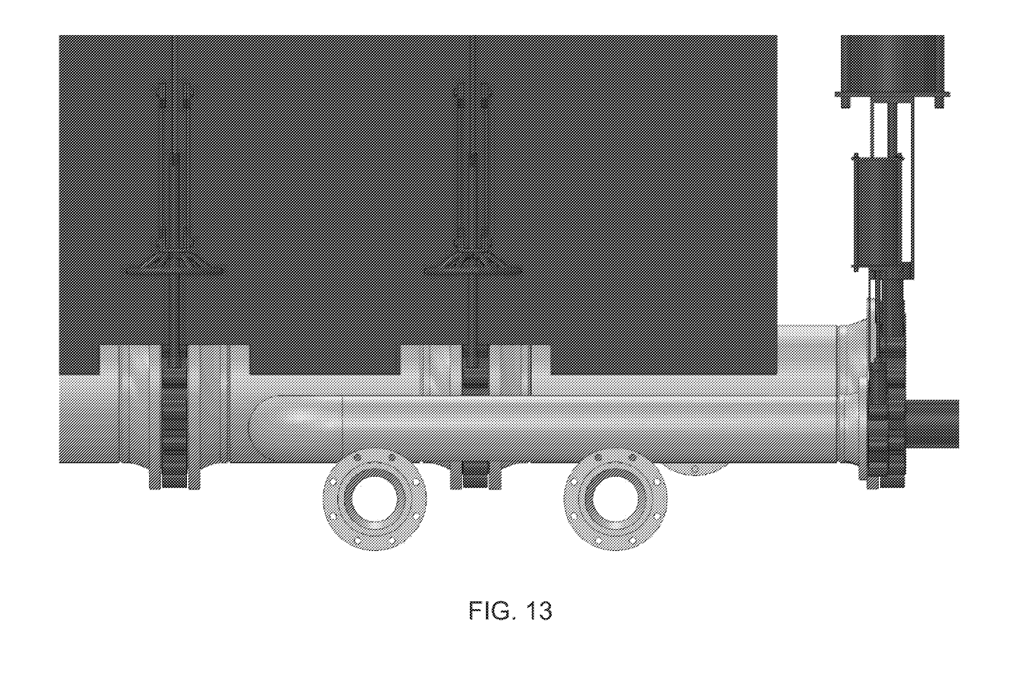

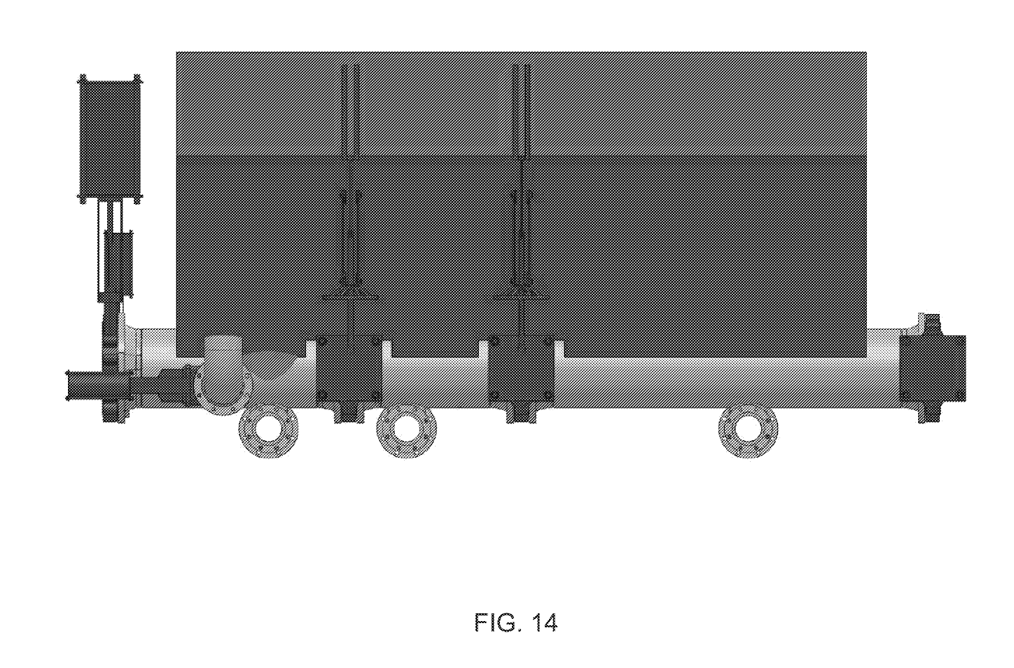

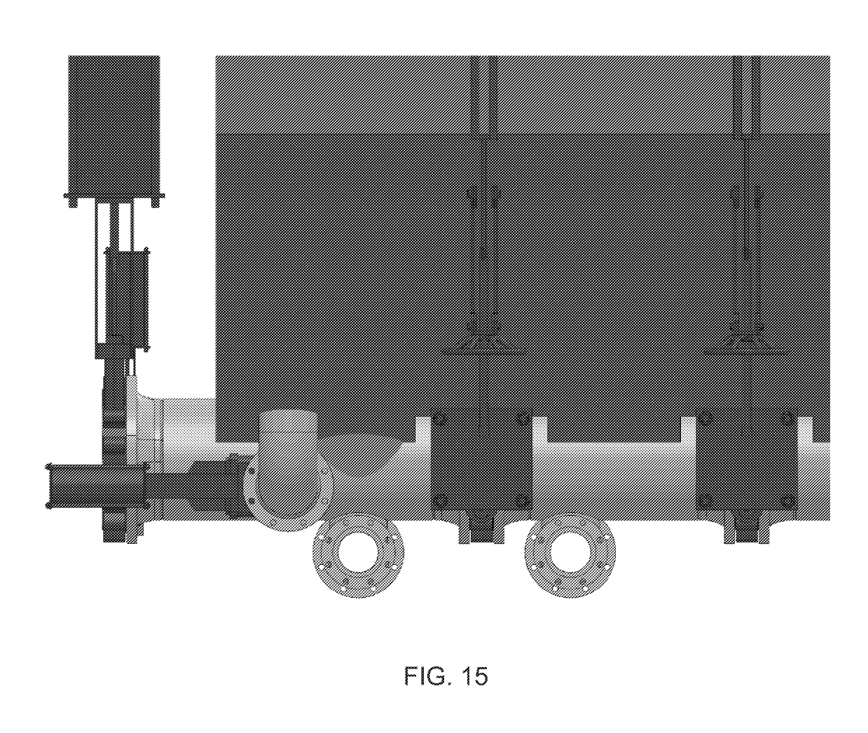

FIGS. 5-15 depict various views of the example shaker pit of FIG. 1. For example, FIGS. 5-6 depict top views of the example shaker pit of FIG. 1. FIG. 6 depicts a bottom view of the example shaker pit of FIG. 1. FIGS. 7-11 depict end views of the example shaker pit of FIG. 1. FIGS. 12-15 depict side views of the example shaker pit of FIG. 1.

In some examples, methods of moving fluid may be provided. A shaker pit may receive a fluid (e.g., drilling fluid) in its first pit. The fluid may include liquid(s) and/or solid(s). The fluid may be partially restricted from flowing from the first pit to a second pit. The fluid may also be partially restricted from flowing from the second pit to a third pit. At least some of the liquid may be channeled and/or directed into a pipe that extends at least partially into the shaker pit.

In some examples, the fluid may be slowed by one or more retention walls. The retention walls may slow the fluid such that at least some of the solids settle near the bottom of the shaker pit. In this manner, solids may be separated and/or removed from the fluid.

The flow of fluid through the shaker pit may be controlled via operation of valves in the shaker pit. For example, valves that separate the first pit from the second pit may be controlled to restrict andor allow fluid to flow between these two pits. Similarly, in some examples, valves that separate the second pit from the third pit may be controlled to restrict andor allow fluid to flow between the two pits.

In some examples, fluid may be channeled into the pipe from the second pit, while, in some examples, fluid may be channeled into the pipe from the third pit, in some examples, fluid may enter pipe from both the second pit and the third pit.

In some examples, a cleaning fluid may be injected into the shaker pit (e.g., into the second pit) via a cleaning pipe to clean and/or wash the shaker pit.

In some examples, drilling fluid in the third pit may be at a level that is higher than an inlet of an overflow pipe (that vertically extends from the pipe). In this manner, fluid may drain and/or be channeled with the assistance of gravity to the pipe. In other words, the fluid may exit the shaker pit via the overflow pipe.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. An apparatus, comprising:
a shaker pit comprising a first pit, a second pit, and a third pit, the shaker pit adapted to receive fluid, and
a pipe in fluid communication with and extending horizontally through at least a portion of the first, pit, the second pit, and the third pit, the pipe adapted to channel at least a portion of the fluid out of the shaker pit.

2. The apparatus of claim 1, wherein the first pit includes one or more retention walls, each respective retention wall adapted to decrease a flow of the fluid in the first pit.

3. The apparatus of claim 1,
wherein the first pit and the second pit are divided by a first divider wall, and
wherein the second pit and the third pit are divided by a second divider wall.

4. The apparatus of claim 3, wherein the first divider wall includes one or more valves, each valve adapted to selectively restrict the fluid from flowing from the first pit to the second pit.

5. The apparatus of claim 3, wherein the second divider wall includes one or more valves, each valve adapted to selectively restrict the fluid from flowing from the second pit to the third pit.

6. The apparatus of claim 1, wherein the pipe includes a bypass pipe that opens into the second pit, the bypass pipe adapted to channel at least a portion of the fluid out of the shaker pit.

7. The apparatus of claim 1, further comprising:
an overflow pipe coupled to the pipe, the overflow pipe extending vertically into the third pit, the overflow pipe adapted to channel at least a portion of the fluid out of the shaker pit.

8. The apparatus of claim 1, further comprising:
a cleaning pipe coupled to the shaker pit, the cleanin pipe adapted to channel a cleaning fluid into the shaker pit.

9. The apparatus of claim 1, wherein the pipe includes one or more valves, each valve adapted to selectively restrict the fluid from flowing through the pipe.

10. The apparatus of claim 1, wherein the fluid comprises a mixture of at least a liquid and a plurality of solids.

11. A method, comprising:
receiving a fluid in a first pit of a shaker pit, the fluid including at least a liquid and a plurality of solids;
at least partially restricting a flow of the fluid from the first pit to a second pit of the shaker pit;
at least partially restricting the flow of the fluid from the second pit to a third pit of the shaker pit; and
channeling at least a portion of the liquid into a pipe that extends at least partially into the shaker pit.

12. The method of claim 1, further comprising:
slowing the flow of the fluid in the first pit via one or more retention walls.

13. The method of claim 11, wherein at least partially restricting the flow of the fluid from the first pit to the second pit includes controlling one or more valves separating the first pit and the second pit.

14. The method of claim 11, wherein at least a portion of the plurality of solids settles in the first pit and does not flow with the fluid to the second pit.

15. The method of claim 11, wherein at least partially restricting the flow of the fluid from the second pit to the third pit includes controlling one or more valves separating the second pit and the third pit.

16. The method of claim 11, wherein at least a portion of the plurality of solids settles in the second pit and does not flow with the fluid to the third pit.

17. The method of claim 11, wherein channeling at least a portion of the fluid into the pipe includes channeling at least a portion of the fluid from the second pit into the pipe.

18. The method of claim 11, wherein channeling at least a portion of the fluid into the pipe includes channeling at least a portion of the fluid from the third pit into the pipe.

19. The method of claim 11, further comprising:
injecting, via a cleaning pipe that extends into the second pit, the shaker pit with a cleaning fluid.

20. The method of claim 11,
wherein the pipe is in fluid com unication with an overflow pipe that extends vertically into the third pit; and
wherein channeling at least a portion of the fluid into the pipe occurs when the fluid in the third pit is higher than an inlet of the overflow pipe.
